(19) United States
(12) Patent Application Publication
(10) Pub. No.: US 2024/0414316 A1
(43) Pub. Date: Dec. 12, 2024

(54) SYSTEMS, METHODS, AND BITSTREAM STRUCTURE FOR VIDEO CODING AND DECODING FOR MACHINES WITH ADAPTIVE INFERENCE

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US)

(73) Assignee: OP Solutions LLC, Amherst, MA (US)

(21) Appl. No.: 18/809,543

(22) Filed: Aug. 20, 2024

Related U.S. Application Data
(63) Continuation of application No. PCT/US2023/013661, filed on Feb. 23, 2023.
(60) Provisional application No. 63/314,036, filed on Feb. 25, 2022.

(51) Int. Cl. H04N 19/102; H04N 19/169

(52) U.S. Cl. CPC H04N 19/102; H04N 19/188

(57) ABSTRACT

Systems and methods are provided for encoding and decoding video data for machine applications, such as Video Coding for Machines, using inference models. An encoder uses an inference selector to determine an appropriate inference model to encode a feature substream. The encoder further employs an inference metadata encoder to encode parameters of the selected inference model into an inference metadata substream, which can be multiplexed with the feature substream to generate an encoded bitstream to send to a decoder site. A decoder receiving the encoded bitstream, extracts the inference metadata, selects the appropriate inference model, and applies that inference model in decoding the feature substream and generating a decoded output signal for machine consumption.

### CROSS REFERENCE TO RELATED APPLICATIONS

This application is a continuation of International Application No. PCT/US2023/013661 filed on Feb. 23, 2023, which application claims the benefit of priority to U.S. Provisional Patent Application, Ser. No. 63/314,036 filed on Feb. 25, 2022, and entitled VCM SYSTEM WITH AN ADAPTIVE INFERENCE, the disclosure of which is hereby incorporated by reference in its entirety.

### FIELD OF THE DISCLOSURE

The present invention generally relates to the field of video compression. In particular, the present invention is directed to methods and systems for hybrid feature video bitstream and decoder.

### BACKGROUND

Although video has been typically thought of as media for human consumption, there are growing applications for the use of video in machine applications, such as advanced industrial processes, autonomous vehicles, IoT applications and the like. These applications are expected to continue to grow and continue to place increasing demands on video channel bandwidth. In some applications, it will be desirable to provide video content which is optimized for both human and machine consumption. Such a bitstream may be referred to as a hybrid bitstream. The utility of the proposed bitstream and decoder is primarily for scenarios where bitstream is transmitted to both human viewers and machines that analyze visual data. The video portion of the bitstream is intended for human viewers, the feature portion of the bitstream is intended for analysis by machines It will be beneficial, therefore, to develop systems and methods that can compress, encode and efficiently transmit video content suitable for both human and machine applications.

The rapid proliferation of edge devices and a dramatic increase in automatic video analysis in conjunction with technologies and concepts such as 5G and IoT has brought forward a need for improvements for video coding which considers machines as end users.

Current state-of-the-art approach is to record, encode, and send to server all signals from the edge device. On the server the bitstream of signals is decoded and passed to the machine algorithms for analysis and processing. Examples of this approach can be found in the popular devices such as Amazon's Echo with Alexa, Google's Home with Assistant, and Apple's devices with Siri, among others. Since these devices process mainly sound (audio signal), the payload is not too large.

In many applications, such as surveillance systems with multiple cameras, intelligent transportation, smart city applications, and/or intelligent industry applications, traditional video coding may require compression of large number of videos from cameras and transmission through a network for both machine consumption and for human consumption. However, for the devices that process video, such as video surveillance systems and residential doorbell cameras, the requirements for network bandwidth and availability are often very high. To mitigate this, the device itself may conduct some of the early stages of processing and send only compressed features to the server. This way the payload is significantly reduced at the expense of computational complexity on the edge. The tradeoff between reduced payload (low network usage) and computational complexity (high battery usage) can be addressed by adaptive delegation. Processing can be done by the edge device entirely, delegated between edge device and the server, or done entirely on the server.

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder.

A format of the compressed data can conform to a standard video compression specification. The compression can be lossy in that the compressed video lacks some information present in the original video. A consequence of this can include that decompressed video can have lower quality than the original uncompressed video because there is insufficient information to accurately reconstruct the original video.

There can be complex relationships between the video quality, the amount of data used to represent the video (e.g., determined by the bit rate), the complexity of the encoding and decoding algorithms, sensitivity to data losses and errors, case of editing, random access, end-to-end delay (e.g., latency), and the like.

Motion compensation can include an approach to predict a video frame or a portion thereof given a reference frame, such as previous and/or future frames, by accounting for motion of the camera and/or objects in the video. It can be employed in the encoding and decoding of video data for video compression, for example in the encoding and decoding using the Motion Picture Experts Group (MPEG)'s advanced video coding (AVC) standard (also referred to as H.264). Motion compensation can describe a picture in terms of the transformation of a reference picture to the current picture. The reference picture can be previous in time when compared to the current picture, from the future when compared to the current picture. When images can be accurately synthesized from previously transmitted and/or stored images, compression efficiency can be improved.

Recent trends in robotics, surveillance, monitoring, Internet of Things, etc. introduced use cases in which significant portion of all the images and videos that are recorded in the field is consumed by machines only, without ever reaching human eyes. Those machines process images and videos with the goal of completing tasks such as object detection, object tracking, segmentation, event detection etc. Recognizing that this trend is prevalent and will only accelerate in the future, international standardization bodies established efforts to standardize image and video coding that is primarily optimized for machine consumption. For example, standards like JPEG AI and Video Coding for Machines are initiated in addition to already established standards such as Compact Descriptors for Visual Search, and Compact Descriptors for Video Analytics. Further improving encoding and decoding of video for consumption by machines and in hybrid systems in which video is consumed by both a human viewer and a machine is, therefore, of growing importance in the field.

### SUMMARY OF THE DISCLOSURE

The present disclosure includes systems and methods for encoding and decoding video data, typically for machine consumption, in which inference models are employed. A suitable bitstream structure is also disclosed.

In one embodiment, an encoder for video, suitable for video coding for machine applications, includes an inference selector and an inference metadata encoder coupled to the inference selector and receiving model selection parameters therefrom. An inference encoder receives the input video signal and inference model selection parameters from the inference selector and routes the input signal to a selected inference model. A feature encoder is coupled to the inference encoder and generates an encoded feature substream. A multiplexor receives the inference metadata substream from the inference metadata encoder and the feature substream from the feature encoder and provides an encoded bitstream.

Preferably, the inference selector produces a recommendation for a best matching inference model for the input signal. It is also preferable that the inference selector recommends an inference model for each unit of the input signal. In some embodiments, the encoder includes a plurality of inference models and the inference encoder operates to route each unit of the input signal to the recommended inference model for that unit.

Embodiments of decoders for video coding for machine applications encoded with an inference encoder is also provided herein. The decoder generally includes a demultiplexor which receives an encoded bitstream having encoded features and inference metadata coded therein. The demultiplexor operates to extract a feature substream and an inference metadata substream from the received bitstream. An inference metadata decoder is coupled to the demultiplexor and receives the inference metadata substream. The inference metadata decoder extracts parameters of an inference model used to encode the bitstream.

The decoder further includes an inference selector which is responsive to the inference model parameters and selects an inference model from a plurality of inference models. A feature decoder is preferably coupled to the demultiplexor, receives the feature substream, and extracts encoded features therefrom. An inference decoder receives the features from the feature decoder and the selected inference model from the inference selector and provides a decoded output signal for machine consumption.

Preferably, the bitstream comprises a stream level header having data that can be used by the demultiplexor to extract the feature substream and inference metadata substream from the bitstream. The inference metadata substream may further comprise an inference metadata header and an inference metadata payload, and the inference metadata decoder may use information in the inference metadata header to extract and decode the inference metadata payload. The feature substream may include a feature stream header and a feature stream payload and the feature stream header may be used by the feature decoder to decode the feature stream payload.

In the decoder, the inference selector preferably produces a recommendation for a best matching inference model for the input signal. The inference selector preferably recommends an inference model for each unit of the input signal. In some embodiments, the decoder has a plurality of inference models and the inference encoder operates to route each unit of the input signal to the recommended inference model for that unit of the input signal.

A bitstream architecture for image information encoded using an inference model generally includes a stream level header, a feature substream comprising a feature stream header and a feature stream payload, and an inference metadata substream comprising an inference metadata header and an inference metadata payload.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a simplified block diagram of an exemplary embodiment of an encoder and decoder suitable for use in hybrid video applications;

FIG. 2 is an illustration of an exemplary embodiment of a hybrid bitstream structure;

FIG. 3 is an illustration of an exemplary embodiment of a hybrid bitstream structure;

FIG. 4 is a flow diagram illustration of an exemplary embodiment of a decoding process for a hybrid bitstream;

FIG. 5 is a flow diagram illustrating a decoding mode selection suitable for use in exemplary embodiments of the current decoding processes;

FIG. 6 is a block diagram illustrating a proposed VCM system with inference encoding;

FIG. 7 is a block diagram illustrating illustrative sub-components of the inference selector and inference encoder components;

FIG. 8 is an exemplary bitstream structure suitable for use with disclosed encoders and decoders using adaptive inference encoding.

FIG. 9 is a simplified block diagram of an exemplary embodiment of a video decoder;

FIG. 10 is a simplified block diagram of an exemplary embodiment of a video encoder; and

FIG. 11 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

The present disclosure is directed to systems and methods for hybrid video data encoding and decoding. The process of coding video for use in machine processes is often referred to as video coding for machines or VCM. As used herein, the term VCM refers broadly to video coding and decoding for machine consumption and is not limited to a specific proposed protocol. In this regard, VCM refers generally to processes suitable for coding video in any manner suitable for machine processing, machine analysis and machine vision tasks, including but not limited to systems and methods applicable to a technical standard being contemplated by the MPEG ad hoc working group referred to as the MPEG VCM group. The adaptive nature of the proposed system allows flexibility in light of the various modalities of the input signals, as well as multiple tasks that might be targeted by the given system.

At a decoder site it will be appreciated that video may be decoded for human vision and features may be decoded for machines. Systems which provide video for both human vision and for machine consumption are sometimes referred to as hybrid systems. The systems and methods disclosed herein are intended to apply to machine-based systems as well as hybrid systems.

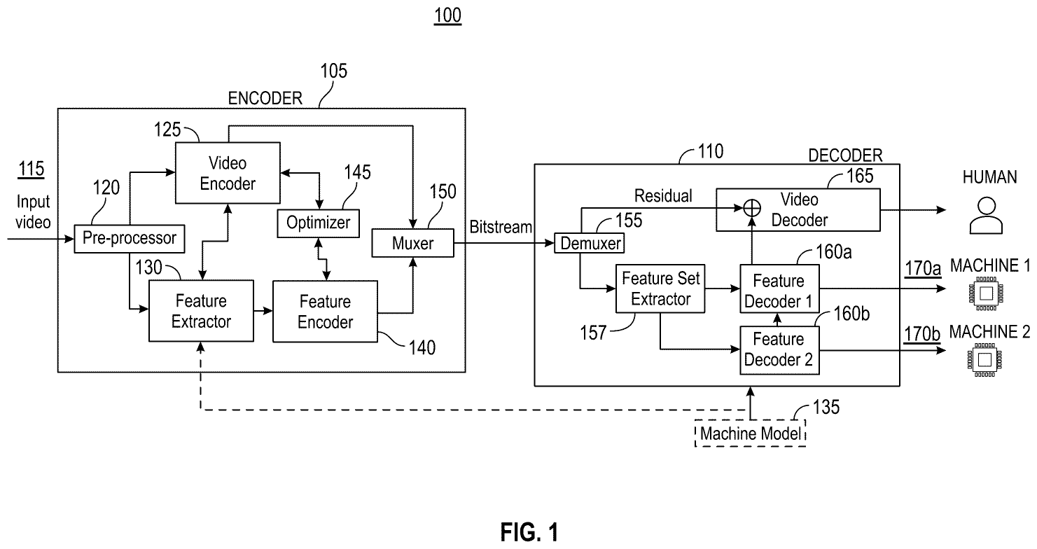

FIG. 1 is a simplified block diagram illustrating a conceptual architecture of the VCM system for hybrid video data includes an encoder 105 and decoder 110. As can be seen in FIG. 1, input to the encoder is a video stream 115, usually in the form of a raw video, such as from a camera or other video generation system. Encoder 105 outputs a bitstream which is subsequently sent to the decoder, which decodes it into an output that is consumed by humans and/or machines. VCM Encoder 105 receives the input video 115 and passes it through a pre-processor/video splitter 120. The pre-processor 120 splits the received video data stream into two components: a video component that is passed to video encoder (e.g., a RGB to YUV conversion), and a stream that is passed to the feature extractor 130. The stream that is passed to the feature extractor 130 is converted to an appropriate format if needed. It can also be quantized or in some other way down-sampled as needed by the feature extractor 130.

A “feature,” as used in this disclosure, is a specific structural and/or content attribute of data. Examples of features may include SIFT, audio features, color hist, motion hist, speech level, loudness level, or the like. Features may be time stamped. Each feature may be associated with a single frame of a group of frames. Features may include high level content features such as timestamps, labels for persons and objects in the video, coordinates for objects and/or regions-of-interest, frame masks for region-based quantization, and/or any other feature that may occur to persons skilled in the art upon reviewing the entirety of this disclosure. As a further non-limiting example, features may include features that describe spatial and/or temporal characteristics of a frame or group of frames. Examples of features that describe spatial and/or temporal characteristics may include motion, texture, color, brightness, edge count, blur, blockiness, or the like.

The video encoder 125 is preferably configured to compresses/encode the video stream in two available modes, a “basic mode” and a “feature-compensated mode”. When operating in the “basic mode” the video encoder 125 is operating as a standard video encoder, such as a standard compliant decoder for H.264, HEVC, AVC, VVC video coding standards, with optional addition of a two-way connection with the feature extractor 130. In this mode video sub-stream is decodable by any decoder which is compliant with a given standard of the bitstream. This connection from the video encoder 125 to the feature extractor 130 may be used to provide additional information that can be used for more efficient compression, especially in the perceptual domain. The video encoder 125, on the other hand, can provide useful feedback to the feature extractor 130, such as motion information, scene change information, etc.

In the “feature-compensated mode” the video encoder 125 preferably receives both the input video and the feature extractor feedback. Based on the feature maps it estimates and encodes the residual difference between the maps and the input picture.

Feature-compensated mode (FCM) is a video encoding/decoding mode in which the video sub-stream is comprised of the residual data, obtained by the encoding of the difference between feature data and input video data. During decoding, this residual can be combined with the baseline feature data. Baseline feature data can be obtained by the video decoder from the feature decoder. Baseline feature data can be equal to the unmodified output of the feature decoder, or it can be a subset of the output of the feature decoder. Baseline residual data can be composed of any of the features, or combination of the features and the input video signal. For example, baseline feature data can be composed of the feature maps that result when the input video data is passed through one or more layers of the Convolutional Neural network (CNN). It can also be composed of the visual primitives composed of the features, such as edges, corners or the key points.

The feature extractor 130 converts input pixel stream from the pre-processor 120 into the feature space for machine use. This feature space corresponds with the task that is to be completed by the machine. Some examples of the conversions include the following: edge extraction-using the computer vision algorithm such as Canny edge detection to detect and then extract relevant edges in the input picture; keypoint extraction-using the algorithms such as Scale-Invariant Feature Transform and Speeded Up Robust Features; signal extraction-using the independent component analysis or principal component analysis to extract the most relevant components of the spectrum from the input picture or audio; feature map extraction-using the lower layers of the neural network, such as the Convolutional Neural network, etc., The type of conversion is selected based on the machine model input 135. The copy of the machine model 135 can be stored on the edge device either independently or as a part of an encoder 105. This allows both scalable deployment of the configurable encoder software and the offline operational mode when the network connection to the terminal machine is not available. This input is provided either by the terminal machine in real-time, or from the local storage. Additionally, the feature extractor 130 can take feedback input from the video encoder 125 that optimizes processing

The feature encoder 140 receives the extracted features from the feature extractor 130 and compresses them via standard lossless and lossy techniques that are developed for similar standards (CDVA for example). Although any known methods may be uses, it is preferred that the feature encoder employs mainly a type of entropy coding. An optimizer 145 may be provided to receive inputs from both the video encoder 125 and the feature encoder 140 and provide signals to these respective blocks indicating the presence of overlaps and redundancies in the data that can be further compressed or discarded in the video and/or feature bitstreams. The outputs of the video encoder 125 and feature encoder 140 are provided to a multiplexer, or muxer 150 which combines the two bitstreams into one.

The hybrid decoder 110 receives the encoded hybrid bitstream and passes it to a demultiplexer, or demuxer 155. Demuxer 155 splits the received hybrid bitstream into video and feature bitstreams, in what is essentially a complimentary operation to that of muxer 150. The feature bitstream is then provided to one or more feature decoders 160a, 160b. In the case where multiple different feature sets are used, a feature set extractor 157 may be interposed between the demux 155 and feature decoders to separate individual feature sets from the bitstream and pass them on to the respective feature decoders 160a, 160b. Each feature decoder 160 receives input from the machine model 135 and an individual feature set as an input and decodes it. The machine model 135 can be provided as an input from a remote source or can be included in storage in the decoder 110. In addition, in the “feature-compensated mode” the feature decoder 160 sends specific subset of features to the video decoder 165. The output of the feature decoder 160 is sent to the terminal machine 170. Video decoder 165 is preferably a standard video decoder in the “basic mode”, and a hybrid decoder in the “feature-compensated mode” (with a possibility of using basic mode for both).

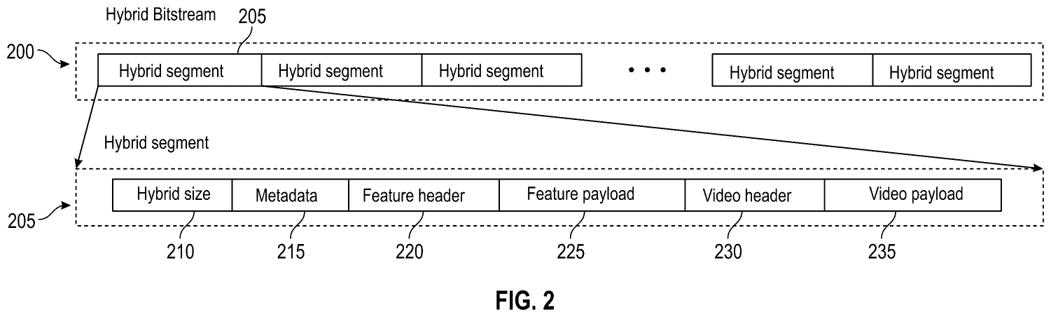

FIG. 2 is a simplified schematic diagram of a bitstream containing both video and features that is output from encoder 105 and transmitted to decoder 110 via a transmission channel. Because the bitstream includes both video and features it is designated as a hybrid bitstream. The top row 200 represents a hybrid bitstream which is a continuous stream comprised of individual units called hybrid segments 205. A sequence of hybrid segments 205 are temporally sequential parts of the continuous stream. Each hybrid segment 205 is preferably further comprised of six components, hybrid size 210, metadata 215, feature header 220, feature payload 225, video header 230 and video payload 235. The components can generally appear in any order, as long as hybrid size 210 is the first component in the hybrid segment 205. In one example, the component order can be implicitly signaled by using “type” and “size” fields in individual components. Alternatively, components 210-235 can contain the “start code” field, which replaces “size” and “type” fields and is instead used for sequential parsing by the decoder. Fields inside the components can be interpreted by the decoder to initialize or update the parameters for decoding.

The hybrid size component 210 is preferably a single field array of numbers that specify the length of each of the components in the sequence. This can be expressed in standard units (usually bits or bytes). As an example, [10, 30, 500, 100, 5000] could mean that there is 10 bytes of metadata information, followed by 30 bytes of feature header data, followed by 500 bytes of feature payload, followed by 100 bytes of video header data, followed by 5000 bytes of video payload. These numbers can be used by the decoder to extract relevant portions of the input bitstream that belong to current segment. If any of the feature or video components are not present, this is signaled by the 0 values in the array.

In the alternative decoding scenario, “start code” is used to mark beginning of the new component of the type that is specified by that “start code”.

The metadata component 215 contains fields that describe segment content, for example, but not limited to:
Input resolution of the video. This may be represented as pixel values of width and height.
Start segment: A binary flag that is set to 1 if the segment is first in the independently decodable sequence of segments and is set to 0 otherwise.
Feature-compensated mode: A binary flag that is set to 1 if the current segment is encoded in the FC mode and is set to 0 otherwise.
Custom fields reserved for future extensions.

The feature header component 220, generally contains fields that describe segment content related to feature, for example, but not limited to:
Scaling factor for resolution change. A single number that represents multiplier of the input video resolution.
Feature type: an index number that designates type of the features present in the payload. For example: (1—edges, 2—key points, 3—neural network, etc.)
Feature type configuration: optional set of fields that carry information about the feature type. For example, a topology of the neural network.
ROI coordinates: array of quartets that designate (implicitly) presence and explicitly locations of regions of interest (ROIs), such as bounding boxes around objects of interest. Each quartet contains numbers designating following pixel values (x-coordinate of the top left corner of the ROI, y-coordinate of the top left corner of the ROI, ROI width, ROI height). For example [(100,50,200,250), (400, 400, 200, 300)], designates two ROIs.
Residual: A flag that designates if the current segment feature payload is used by the video decoder in the FC mode.
Various parameter sets related to the specific feature type.
Custom fields reserved for future extensions.

The feature payload component 225 is the portion of the bitstream that contains encoded feature data needed for the reconstruction of the output features. Feature data can include, for example, key points, edges, motion information, object detections, bounding boxes, feature maps of the neural networks, and similar data that enables image and video analytics applications such as event and action recognition, object detection and tracking, pose estimation, etc. Features may be encoded using entropy and binary coding such as Huffman coding, Arithmetic coding or VLC coding, etc.

The video header component 230 generally contains fields that describe segment content related to video, for example, but not limited to:
Mode: A single number (bit) reserved for signaling Basic or FC mode for the current video segment.
Parameter sets: for example, a picture parameter set that signals configuration of the video decoder. Possibly sequence parameter set also.
Quantization matrices: a set of one or more matrices that carry quantization coefficients used for decoding. Each matrix is identified with the region to which it is applied. Region location can be signaled explicitly or obtained from the feature decoder (as ROI coordinates), together with the residual information, or independently.
Perceptual parameters: quantization scaling and loop filter parameters that are applied in the regions with perceptually significant characteristics (obtained from the feature decoder as ROI regions).
Custom fields reserved for future extensions.

The video payload 235 is the portion of the bitstream that contains encoded video data needed for the reconstruction of the output features.

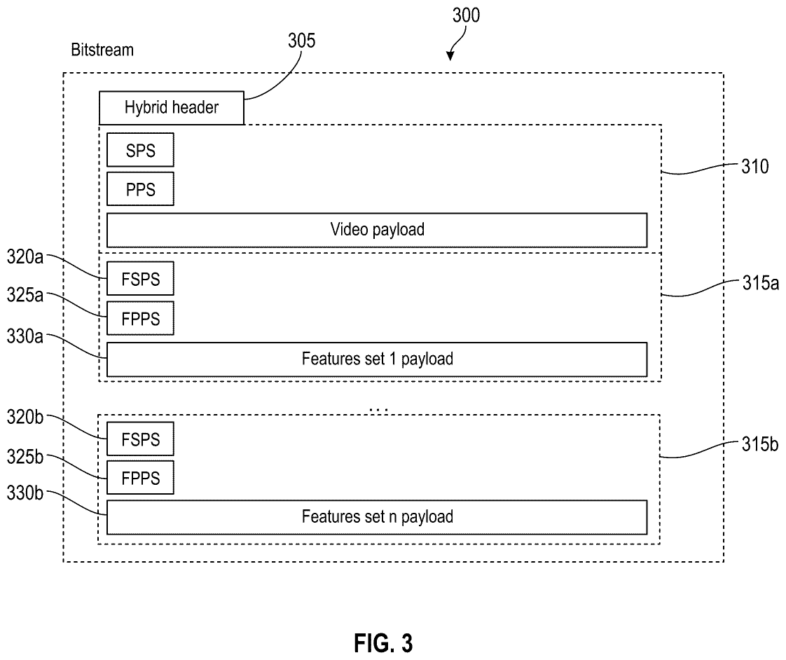

FIG. 3 further illustrates an exemplary hybrid bitstream structure 300. The bitstream includes a hybrid header 305 which contains, for example, a list of zero or one video streams 310 and zero or more feature streams 315a, 315b. The hybrid header 305 preferably contains relevant high-level parameters (used for stream splitting, etc.) and may also contain parameters that signals which mode is used for encoding, i.e., “basic” or “feature-compensated”. Video stream 310 preferably has a standard structure defined in one or more known video coding standards, such as a sequence parameter set (SPS), picture parameter set (PPS), etc. The video stream can be decoded by either VCM or VVC decoder, depending on which mode is used for encoding. Each feature stream 315a, 315b, preferably contains header information, such as a feature sequence parameter set FSPS 320a, 320b and feature picture parameter set FPPS 325a, 325b and a corresponding feature payload 330a, 330b.

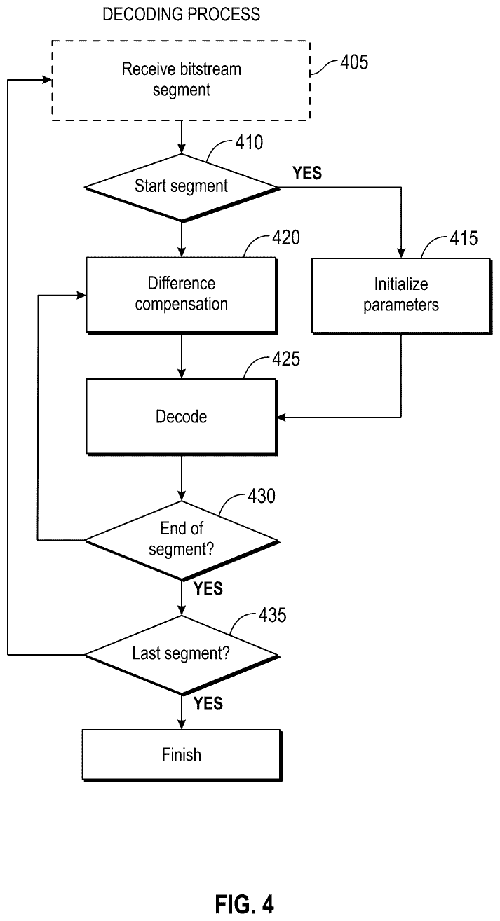

The overview of the decoding process for a hybrid bitstream is described in connection with the flow chart of FIG. 4. The decoder 110 receives a bitstream segment 205 in step 405, reads the metadata 215 and in step 410 determines if the current segment is start segment in a sequence of segments. If it is a start segment, the decoding process advances to step 415 and sets the decoding parameters according to the values in the other fields in the metadata component 215 and the values of the fields in the feature header 220 and video header 230. If the received segment is not the first segment in step 410, the decoding process proceeds with difference compensation calculations in step 420 between the current segment and previous segments. Difference compensation calculations may include motion compensation, or any other type of compensation appropriate for the feature sets. Following steps 415 and 420, processing proceeds to decode the payload data in step 425. The payload data is tested in step 430 to determine if processing has reached the end of the segment. If the end of the segment is not reached in Step 430, processing returns to step 420. If the segment is a last segment in the sequence of segments it finishes the decoding of the current group of segments. In step 435 the decoder determines whether the last segment has been decoded. If not, processing returns to step 405 to decode the next segment.

Each group of segments is a sequence of one or more consecutive segments. Each group of segments is independently decodable. Video segments within one group of segments are independently decodable in relation to other video segments but might depend on the feature segments from the same group of segments.

In each hybrid segment or group of segments in the hybrid bitstream there might be one or zero feature segments and one or zero video segments. The presence of the feature and video segments can be determined implicitly from the values of the “hybrid size” component 210. The mode of the decoder can be determined based on a “feature-compensated mode” (FCM) flag for each segment.

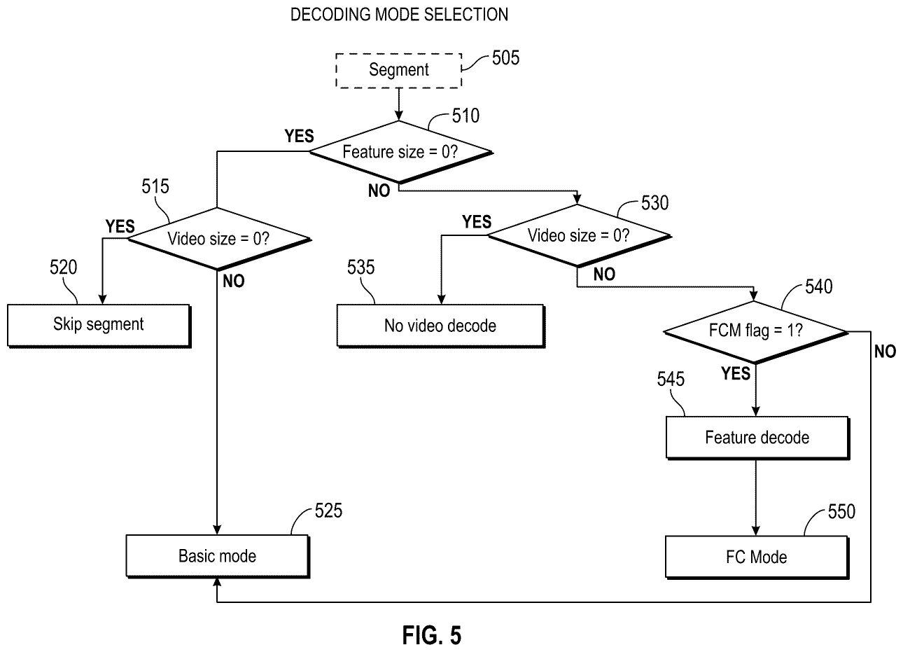

Decoding mode selection using the decision process for the parsing of the FCM flag together with the parsing of the size parameters for segment presence determination is further described in connection with the flow chart depicted in FIG. 5.

Decoder receives the hybrid segment in step 505 and in step 510 determines if the feature segment is present by evaluating the feature size. If feature segment is not present (size of it is 0), the decoding process checks the size in step 515 to determine if a video segment is present. If it is not (size of it is 0), the current segment is skipped (step 520). If the video segment is present in step 515 after determining that no feature segment was present in the segment in step 510, the mode is set to “Basic mode” in step 525, and only video is decoded.

If in step 510, the feature segment is present (feature size is not 0), and video segment is not (video size=0) (step 30), then there is no video decoding, only the features are decoded (step 535). If both feature and video segments are present, in step 540 the decoder checks the FCM flag from the metadata component 215. If the FCM mode is signaled (FCM=1), then the feature segment is first decoded (step 545) and baseline feature data is passed to the video decoder that operates in the FC mode (step 550), thus combining baseline feature data with the residual to obtain the video output. If in step 540 the FCM flag is set to 0, the feature segment and video segments are decoded independently, and the video decoder operates in the “Basic mode”

### Adaptive Inference

A further embodiment of the present disclosure is a system for the video coding for machines (VCM) that uses adaptive inference selection for image, video and feature coding.

In general, the term “inference” in the context of machine learning-based systems refers to the process of using a trained machine learning algorithm to make a prediction. In the case of video encoding and decoding applications disclosed herein, inference model maps can be used to route input data to the optimal inference algorithm that is available to the encoder. If the encoder has multiple inference algorithms at its disposal, the input data is preferably matched with the algorithm that is best for analyzing that data. For example, audio data may be best analyzed with an algorithm that is optimized for audio signals (e.g., long short-term memory networks), visual data is best analyzed with the algorithm that is optimized for the visual signals (e.g., convolutional neural networks). Furthermore, same algorithm (e.g., neural network) can be tuned, such as by training, for a particular class of objects within same data modality, or to a particular task. If multiple versions of the same algorithm with different tuning are available to the encoder, the system preferably determines which specific model to use for the input data it receives. Without the inference model providing such routing, the system may have to send the input data to all available inference algorithms simultaneously, thereby incurring a high computational cost and producing a much larger message to be sent to the decoder.

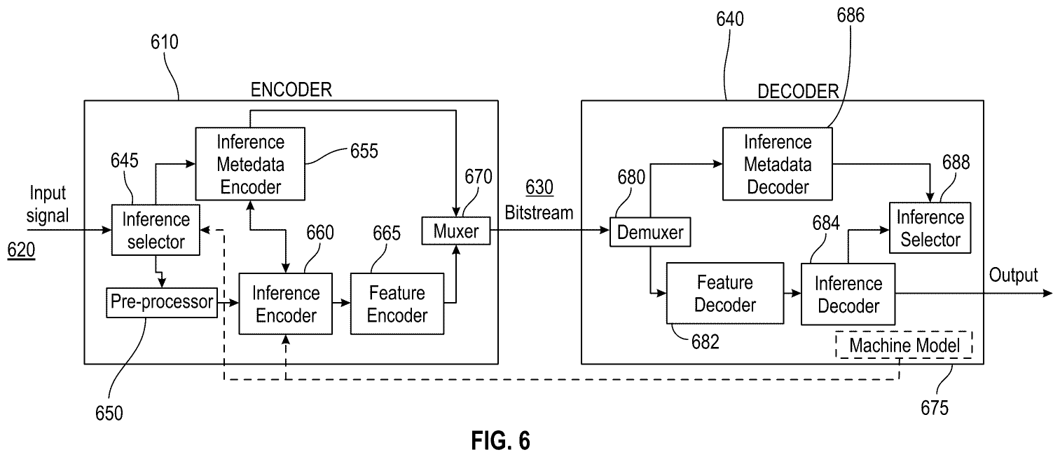

Referring to FIG. 6, VCM encoder 610 receives an input signal 620, such as image, video, sound, infra-red image, or similar from a source such as a camera or some other recording or input device and passes it through the inference components which compress the signal and associated metadata into bitstream 630 which is sent to the VCM decoder 640. VCM decoder 640 decompresses the compressed bitstream 630 and produces output which can be same as the input signal (lossless compression), or some other representation or transformation of the input signal (including the lossy version of it). Typically, the output signal is then passed to the task completion neural network or similar system for decision making. VCM decoder 640 and the decision-making system might reside on a single machine terminal or be distributed to the remote locations. In some embodiments, the VCM encoder 610 may be deployed to the edge devices, such as IoT nodes, vehicles, perimeter camera systems, and the like.

The VCM encoder 610 with adaptive inference preferably includes and inference selector 645 which receives the input signal 620. The inference selector 645 is coupled to a pre-processor 650 and inference metadata decoder 655. The pre-processor 650 is coupled to an inference encoder 660, which is also preferably in communication with the machine model 675 at the decoder site. The output of inference encoder 660 is provided to a feature encoder 665. A multiplexor 670 receives the output from the feature encoder 665 and inference metadata encoder 655 and generates an encoded bitstream 630 therefrom.

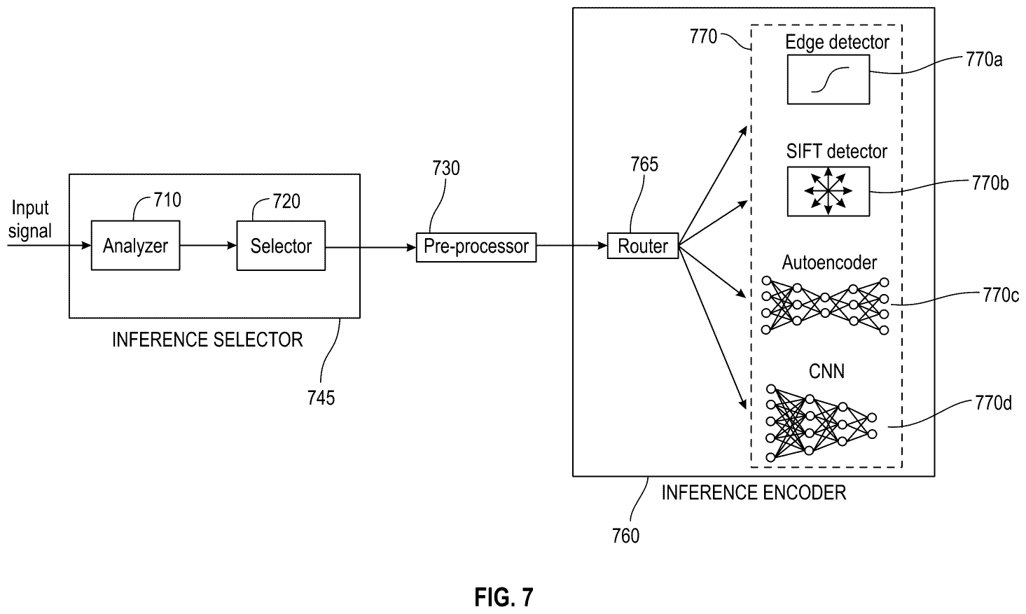

FIG. 7 is a block diagram further illustrating certain features of the encoder 610. As shown in FIG. 7, the inference selector 745 passes the input signal through an analyzer 720 which conducts spatio-temporal analysis of the input signal and produces the recommendation for the best-matching inference model. The analyzer 710 can apply simple filters in different frequency bands to identify the frequency composition of the input signals (texture and gradient for visual signals, waveform of the audio signals), and compare them with a template of the standardized input signals expected by each inference model. In another example, the analyzer 710 can detect video at a certain resolution, frame rate, and color space, and match it with the convolutional neural network (CNN), that is appropriate for such signal. In cases when the inference model is predetermined, the analyzer can serve as a pass-through sub-component, either by the absence of other inference models or by the signal from the machine model that is received by the inference selector before the processing starts (dashed line connection depicted in FIG. 6).

The analyzer 710 recommendation is passed together with the signal through the selector 720 sub-component, which sets the selection parameter to the appropriate value for each unit of the input signal that is passed. Different units of the input signal, such as different frames of the video, can have different inference selection parameters. Input video stream together with the inference selection parameters is then passed to the pre-processor 730.

The preprocessor 730 takes in the input signal unit along with the inference selection parameter(s) and processes the unit to fit the input parameters of the selected inference model. For example, the image or the video frame can be downscaled and/or cropped to a lower resolution, and/or the color space (YCbCr for example) can be converted to the one that is accepted by the convolutional neural network (RGB for example). The audio signal can be converted to a spectral representation or down-sampled in the temporal domain. The pre-processed signal is then passed to the inference encoder 760.

The inference encoder 760 receives the pre-processed input signal units of the bit stream and passes it through a router 765 which parses the inference selection and sends the input signal unit to a selected inference model 770. The inference encoder 760 can contain one or more inference models 770a-770d. Inference models 770 can be pre-loaded on the encoder 610 or sent to the encoder 610 by the machine model component 675 as depicted with the dashed lines in FIG. 6. Once the new model is sent to the encoder 610, the inference selection component 645 receives associated updates with the parameters of the new inference model. Inference models 770 can take the form of any standard models for the input signal processing, such as autoencoder (AE) 770c, generative adversarial network (GAN), convolutional neural network (CNN) 770d, as well as simpler processors, such as edge detector 770a, texture detector, scale-invariant feature transform (SIFT) 770b, Fast Fourier Transform (FFT), etc. Output of the inference encoder 660/760 is passed to the feature encoder 665.

It will be appreciated by a person of ordinary skill in the art that while FIG. 7 illustrates a selection of four possible inference models, this is merely illustrative and the proposed system does not have a limit on the number of inference models used which can be more or less than the four that are illustrated.

Referring back to FIG. 6, the inference metadata encoder 655 receives the inference model selection parameters from the inference encoder 660 and encodes them in the symbolic stream associated with time-stamps of each unit that is processed by the inference encoder 660. A symbolic stream can be produced using standard statistical models for strings, such as entropy coding, variable-length coding, or similar. Output of the inference metadata encoder 655 is coupled to a multiplexor 670 to form a component of the bitstream 630.

Still referring to FIG. 6, the feature encoder 665 takes the output of the inference encoder 660 and applies transforms and compression to it. For example, a feature map from the neural network can be rescaled and joined to the other feature maps to produce single image or frame of the video and subsequently compressed using state-of-the-art image or video coding such as versatile video coding (VVC) or other advanced video coding standard. Output of the feature encoder is a feature sub-stream that is passed to the multiplexor 670.

The multiplexor 670 receives the inference metadata sub-stream from inference metadata encoder 655 and the feature sub-stream from the feature encoder 660 and applies a multiplexing operation, thereby producing the unified bitstream 630 that is sent over a transmission channel to the VCM decoder 640.

The VCM decoder 640 with the adaptive inference preferably includes a demultiplexor 680 which receives the bitstream 630 and parses it to extract an inference metadata sub-stream and a feature sub-stream. The feature sub-stream is provided to a feature decoder 682 which applies the inverse operations compared to the feature encoder 665 to extract the features that are then passed to an inference decoder 684.

An inference metadata decoder 686 is coupled to the demultiplexor 680, receives the inference metadata sub-stream, parses it and decodes the symbolic representation of the parameters that are then passed to an inference selector 688. The inference selector 688 takes the inference metadata parameter that defines the inference model 770 used for encoding and passes that information to the inference decoder 684.

The inference decoder 684 takes in the features from the feature decoder 682 and the inference model selection and passes the features through the appropriately selected inference model (e.g., 770). In cases where the features are themselves sufficient for the decision-making, the inference decoder 684 can pass the features through to the output. In cases where a second stage of the inference decoding 684 is needed (such as in the cases where autoencoder is split and distributed to the VCM encoder and VCM decoder, or in cases where the neural network is split and a “backbone” is sent to the VCM encoder 610, and “head” is sent to the VCM decoder 640, etc.) the inference decoder 684 passes the features through the selected inference model and produces the output corresponding to the encoded input signal, that is used for machine consumption.

A machine model 675 may be employed and can optionally be implemented in the VCM decoder 640 or situated in a remote location. Machine model 675 contains information about the tasks and the inference models. The machine model 675 can be pre-programmed or manually operated to produce the optimal outcomes and maintain communication with the VCM encoder 610 (and VCM decoder 640, if remote from the decoder).

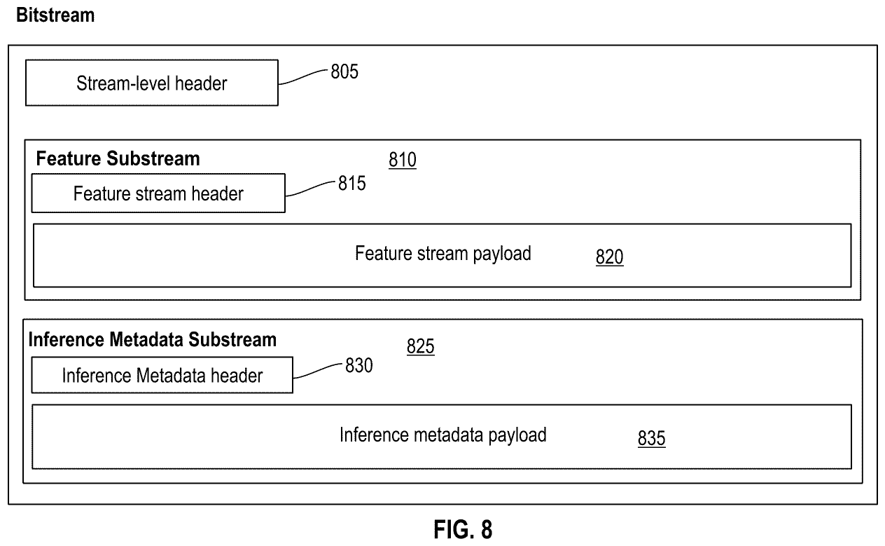

An example of the structure of a bitstream suitable for use in the present systems and methods is depicted in FIG. 8. Stream-level header 805 contains high level syntax describing the presence of the substreams and contains parameters of such substreams, such as length, duration, format, etc. This information is used by the demuxer 680 in the VCM decoder 640 to extract substreams.

Feature substream 810 contains feature stream header 815 which describes the feature stream payload 820 in terms of length, format, and other pertinent parameters. Feature stream header 815 can be used by the feature decoder 682 to extract and decode the feature stream payload 820.

Inference metadata substream 825 contains the inference metadata header 830 which contains parameters describing the length, format, and type of the inference metadata payload 835. Alternatively, instead of the complete description of all inference model parameters, the VCM encoder 610 can signal the index of the used inference model in the look-up table or a list that is predetermined and agreed upon between the decoder 640 and the encoder 610 (which can be facilitated using the machine model component). This list can be maintained by a central registration authority which updates it and signals the updates to the end users. Inference metadata header 830 can be used by the inference metadata decoder 686 to extract and decode the inference metadata payload 835.

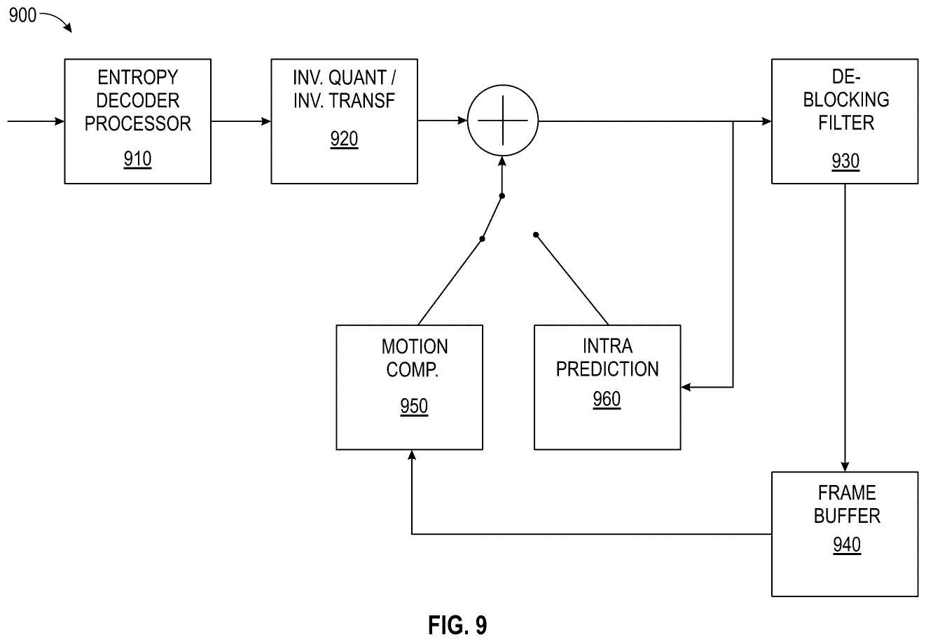

FIG. 9 is a system block diagram illustrating an example video decoder 900, such as shown as video decoder 165 in FIG. 1, capable of decoding the video portion of a hybrid bit stream. The decoder 900 includes an entropy decoder processor 910, an inverse quantization and inverse transformation processor 920, a deblocking filter 930, a frame buffer 940, motion compensation processor 950 and intra prediction processor 960.

In operation, video portion of the hybrid bit stream can be received by the decoder 900 and input to entropy decoder processor 910, which entropy decodes portions of the bit stream into quantized coefficients. The quantized coefficients can be provided to inverse quantization and inverse transformation processor 920, which can perform inverse quantization and inverse transformation to create a residual signal, which can be added to the output of motion compensation processor 950 or intra prediction processor 960 according to the processing mode. The output of the motion compensation processor 950 and intra prediction processor 960 can include a block prediction based on a previously decoded block. The sum of the prediction and residual can be processed by deblocking filter 930 and stored in a frame buffer 940.

In an embodiment, and still referring to FIG. 9 decoder 900 may include circuitry configured to implement any operations as described above in any embodiment as described above, in any order and with any degree of repetition. For instance, decoder 900 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

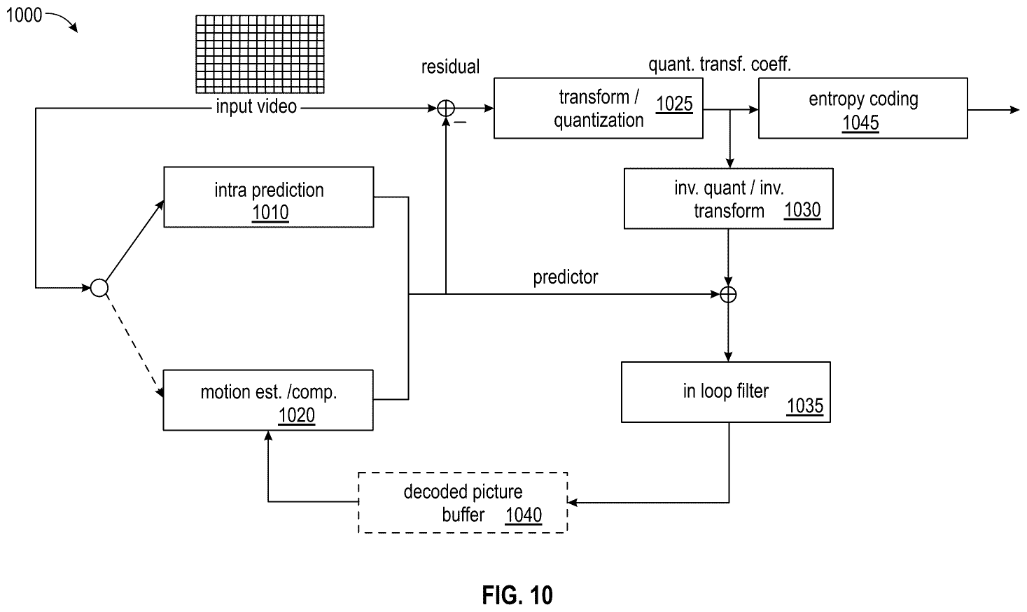

FIG. 10 is a system block diagram illustrating an example video encoder 1000 suitable for encoding the video portion of a hybrid bitstream, such as video encoder 125 shown in FIG. 1. The example video encoder 1000 receives an input video 1005, which can be initially segmented or dividing according to a processing scheme, such as a tree-structured macro block partitioning scheme (e.g., quad-tree plus binary tree). An example of a tree-structured macro block partitioning scheme can include partitioning a picture frame into large block elements called coding tree units (CTU). In some implementations, each CTU can be further partitioned one or more times into a number of sub-blocks called coding units (CU). The final result of this portioning can include a group of sub-blocks that can be called predictive units (PU). Transform units (TU) can also be utilized.

Still referring to FIG. 10, example video encoder 1000 includes an intra prediction processor 1015, a motion estimation/compensation processor 1020 (also referred to as an inter-prediction processor) capable of supporting adaptive cropping, a transform/quantization processor 1025, an inverse quantization/inverse transform processor 1030, an in-loop filter 1035, a decoded picture buffer 1040, and an entropy coding processor 1045. Bit stream parameters can be input to the entropy coding processor 1045 for inclusion in the output bit stream 1050.

In operation, and continuing to refer to FIG. 10, for each block of a frame of the input video 1005, whether to process the block via intra picture prediction or using motion estimation/compensation can be determined. The block can be provided to the intra prediction processor 1010 or the motion estimation/compensation processor 1020. If the block is to be processed via intra prediction, the intra prediction processor 1010 can perform the processing to output the predictor. If the block is to be processed via motion estimation/compensation, the motion estimation/compensation processor 1020 can perform the processing including using adaptive cropping, if applicable.

Still referring to FIG. 10, residual can be formed by subtracting the predictor from the input video. The residual can be received by the transform/quantization processor 1025, which can perform transformation processing (e.g., discrete cosine transform (DCT)) to produce coefficients, which can be quantized. The quantized coefficients and any associated signaling information can be provided to the entropy coding processor 1045 for entropy encoding and inclusion in the output bit stream 1050. The entropy encoding processor 1045 can support encoding of signaling information related to encoding the current block. In addition, the quantized coefficients can be provided to the inverse quantization/inverse transformation processor 1030, which can reproduce pixels, which can be combined with the predictor and processed by the in loop filter 1035, the output of which is stored in the decoded picture buffer 1040 for use by the motion estimation/compensation processor 1020 that is capable of adaptive cropping.

With continued reference to FIG. 10, although a few variations have been described in detail above, other modifications or additions are possible. For example, in some implementations, current blocks can include any symmetric blocks (8×8, 16×16, 32×32, 64×64, 128×128, and the like) as well as any asymmetric block (8×4, 16×8, and the like).

Still referring to FIG. 10, in some implementations, a quadtree plus binary decision tree (QTBT) can be implemented. In QTBT, at the Coding Tree Unit level, the partition parameters of QTBT are dynamically derived to adapt to the local characteristics without transmitting any overhead. Subsequently, at the Coding Unit level, a joint-classifier decision tree structure can eliminate unnecessary iterations and control the risk of false prediction. In some implementations, LTR frame block update mode can be available as an additional option available at every leaf node of the QTBT.

In some implementations, and with continued reference to FIG. 10, additional syntax elements can be signaled at different hierarchy levels of the bit stream. For example, a flag can be enabled for an entire sequence by including an enable flag coded in a Sequence Parameter Set (SPS). Further, a CTU flag can be coded at the coding tree unit (CTU) level.

Still referring to FIG. 10, encoder 1000 may include circuitry configured to implement any operations as described above in any order and with any degree of repetition. For instance, encoder 1000 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 1000 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 10, non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using digital electronic circuitry, integrated circuitry, specially designed application specific integrated circuits (ASICs), field programmable gate arrays (FPGAs) computer hardware, firmware, software, and/or combinations thereof, as realized and/or implemented in one or more machines (e.g., one or more computing devices that are utilized as a user computing device for an electronic document, one or more server devices, such as a document server, etc.) programmed according to the teachings of the present specification, as will be apparent to those of ordinary skill in the computer art. These various aspects or features may include implementation in one or more computer programs and/or software that are executable and/or interpretable on a programmable system including at least one programmable processor, which can be special or general purpose, coupled to receive data and instructions from, and to transmit data and instructions to, a storage system, at least one input device, and at least one output device.

Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, Programmable Logic Devices (PLDs), and/or any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

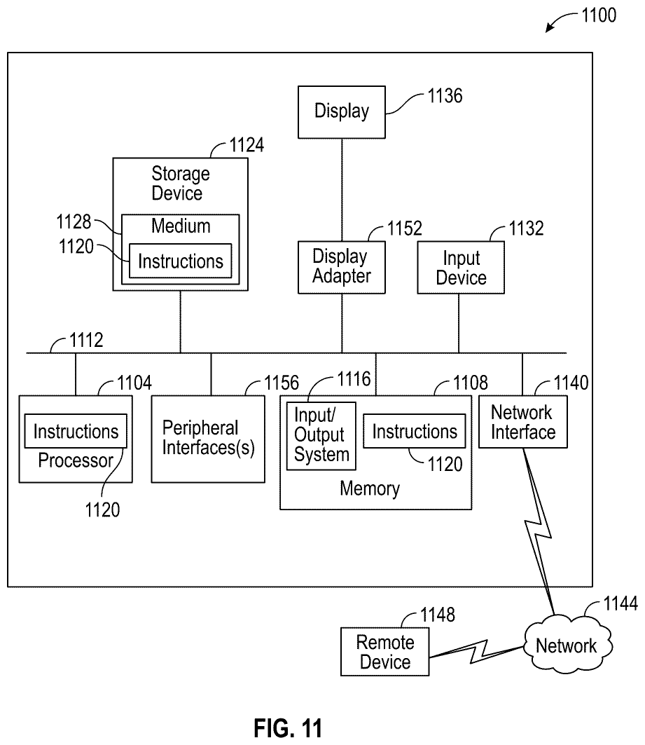

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

It is to be noted that any one or more of the aspects and embodiments described herein may be conveniently implemented using one or more machines (e.g., one or more decoder and/or encoders that are utilized as a user decoder and/or encoder for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

The foregoing has been a detailed description of illustrative embodiments of the invention. Various modifications and additions can be made without departing from the spirit and scope of this invention. Features of each of the various embodiments described above may be combined with features of other described embodiments as appropriate to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments as disclosed herein.

Accordingly, this description is meant to be taken only by way of example, and not to otherwise limit the scope of this invention.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. An encoder for video coding for machine applications, the encoder comprising:
an inference selector;
an inference metadata encoder coupled to the inference selector and receiving inference model selection parameters from the inference encoder and encoding said parameters into an inference metadata substream;
an inference encoder, the inference encoder receiving the input signal and inference model selection parameters from the inference selector and routing the input signal to a selected inference model;
a feature encoder, the feature encoder being coupled to the inference encoder and generating an encoded feature substream;
a multiplexor, the multiplexor receiving the inference metadata substream from the inference metadata encoder and the feature substream from the feature encoder and providing an encoded bitstream therefrom.

2. The encoder of claim 1, wherein the inference selector produces a recommendation for a best matching inference model for the input signal.

3. The encoder of claim 2, wherein the inference selector recommends an inference model for each unit of the input signal.

4. The encoder of claim 3, wherein the encoder comprises a plurality of inference models and the inference encoder operates to route each unit of the input signal to the recommended inference model for that unit.

5. A decoder for video for video coding for machine applications encoded with an inference encoder, the decoder comprising:
a demultiplexor, the demultiplexor for receiving an encoded bitstream having features and inference metadata encoded therein, the demultiplexor generating a feature substream and an inference metadata substream;
an inference metadata decoder, the inference metadata decoder being coupled to the demultiplexor and receiving the inference metadata substream and extracting parameters of an inference model used to encode the bitstream therefrom;
an inference selector responsive to the inference model parameters and selecting an inference model from a plurality of inference models;
a feature decoder coupled to the demultiplexor, the feature decoder receiving the feature substream and extracting encoder features therefrom; and
an inference decoder, the inference decoder receiving the features from the feature decoder and the selected inference model from the inference selector and providing a decoded output signal therefrom.

6. The decoder of claim 5, wherein the bitstream comprises a stream level header, the stream level header having data used by the demultiplexor to extract the feature substream and inference metadata substream from the bitstream.

7. The decoder of claim 5, wherein the inference metadata substream further comprises an inference metadata header and an inference metadata payload,

8. The decoder of claim 6, wherein the inference metadata header 830 is used by the inference metadata decoder 686 to extract and decode the inference metadata payload.

9. The decoder of claim 5, wherein the feature substream comprises a feature stream header and a feature stream payload, wherein the feature stream header is used by the feature decoder to decode the feature stream payload.

10. The decoder of claim 5, wherein the inference selector produces a recommendation for a best matching inference model for the input signal.

11. The decoder of claim 10, wherein the inference selector recommends an inference model for each unit of the input signal.

12. The decoder of claim 11, wherein the encoder comprises a plurality of inference models and the inference encoder operates to route each unit of the input signal to the recommended inference model for that unit.

13. A bitstream for image information encoded using an inference model comprising:
a stream level header;
a feature substream comprising a feature stream header and a feature stream payload; and
an inference metadata substream comprising an inference metadata header and an inference metadata payload.
